(19) United States
(12) Patent Application Publication
(10) Pub. No.: US 2015/0123866 A1
(43) Pub. Date: May 7, 2015

(54) ANTENNA WITH HIGH ISOLATION

(71) Applicant: FOXCONN INTERCONNECT TECHNOLOGY LIMITED, Grand Cayman (KY)

(72) Inventors: TZU-YAO HWANG, New Taipei (TW); LUNG-SHENG TAI, New Taipei (TW)

(21) Appl. No.: 14/522,603

(22) Filed: Oct. 24, 2014

(30) Foreign Application Priority Data
Nov. 6, 2013 (TW) 102140199

(51) Int. Cl. H01Q 1/52; H01Q 5/00

(52) U.S. Cl. CPC H01Q 1/526; H01Q 5/0027
USPC 343/841

(57) ABSTRACT

An antenna includes a grounding portion extending in a longitudinal direction, a main body and an isolating portion extending from the grounding portion, a metal foil assembled on the grounding portion and a coaxial cable connecting the main body. The grounding portion includes a first section and a second section connecting with each other. The main body extends from the first section while the isolating portion extends from the second section. The isolating portion locates beside the main body in the longitudinal direction and defines a gap therebetween.

### BACKGROUND OF THE INVENTION

1. Field of the Invention

The present disclosure relates to an antenna, and more particularly to a high isolation antenna.

2. Description of Related Art

With the development of technology, more and more portable electronic devices are equipped with wireless transceiver for transmitting wireless signals, so antenna is integrated therein. In order to meet the wireless signal transmission on different frequency band, the portable electronic equipment is often integrated with two or more antennas. However, with the miniaturization tendency of portable electronic devices, the internal space of the electronic device becomes smaller and smaller and the distance between two antennas becomes closer and closer. Thus the isolation therebetween becomes bad and can not meet the normal requirement of each antenna.

In view of the above, an improved antenna is desired to overcome the problems mentioned above.

### SUMMARY OF THE INVENTION

Accordingly, an object of the present disclosure is to provide an antenna with high isolation.

According to one aspect of the present disclosure, an antenna with an isolating portion is provided. The antenna comprises a grounding portion extending in a longitudinal direction, a main body and an isolating portion extending from the grounding portion, a metal foil assembled on the grounding portion and a coaxial cable connecting the main body. The grounding portion comprises a first section and a second section connecting with each other. The main body extends from the first section while the isolating portion extends from the second section. The isolating portion locates beside the main body in the longitudinal direction and defines a gap therebetween.

Other objects, advantages and novel features of the disclosure will become more apparent from the following detailed description when taken in conjunction with the accompanying drawings, in which:

### BRIEF DESCRIPTION OF THE DRAWINGS

FIG. 1 is an assembled, perspective view of an antenna in accordance with a preferred embodiment of the present disclosure;

FIG. 2 is an exploded, perspective view of the antenna shown in FIG. 1;

FIG. 3 is an isolation chart of the antenna shown in FIG. 1;

FIG. 4 is an isolation chart of an antenna without an isolating portion.

### DETAILED DESCRIPTION OF THE INVENTION

Reference will now be made to the drawings to describe a preferred embodiment of the present disclosure in detail.

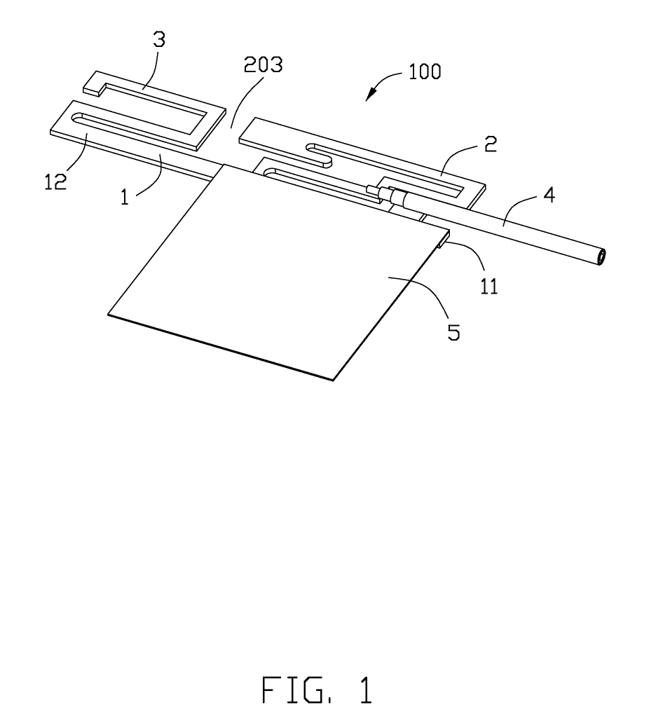

Referring to FIG. 1, an antenna 100 is stamped from a metal plate. The antenna 100 extends in a longitudinal direction, comprising a grounding portion 1 extending in the longitudinal direction, a main body 2 and an isolating portion 3 extending from the grounding portion 1 in a vertical direction perpendicular to the longitudinal direction, a coaxial 4 connecting the main body 2 and a metal foil 5 assembled on the grounding portion 1.

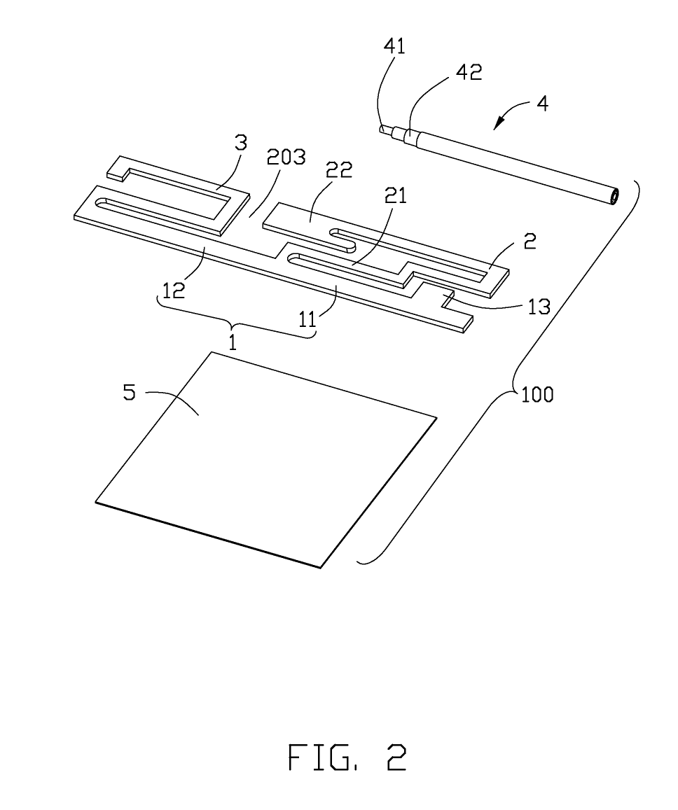

Referring to FIG. 2, the grounding portion 1 comprises a first section 11 and a second section 12 in the longitudinal direction. The main body 2 extends upwardly in the vertical direction from an upper edge of the first section 11. The main body 2 comprises an L-shaped connecting portion 21 and a radiating portion 22 extending from the connecting portion 21. The radiating portion 22 firstly extends upwardly in the vertical direction, then extends in the longitudinal direction, and then extends in the vertical direction again, at last extending backwardly in the longitudinal direction. The connecting portion 21 and the radiating portion 22 defining an opening facing towards the isolating portion 3. The antenna 100 further comprises a tab 13 extending upwardly from the first section 11. The coaxial cable 4 comprises an inner conductor 41 soldering on the joint of the connecting portion 21 and the radiating portion 22, and an outer conductor 42 surrounding the inner conductor 41 for soldering on the tab 13. The antenna 100 works at the frequency bands of 2.4-2.5 GHz and 5.15-5.85 GHz.

The isolating portion 3 extends from an upper edge of the second section 12. The isolating portion 3 is substantially a rectangular frame with a cutout facing opposite to the main body 2. The isolating portion 3 is coplanar with the main body 2 and defines a gap 203 with the main body 2. The metal foil 5 connects the first section 11 of the grounding portion 1. The dimension of the metal foil 5 in the longitudinal direction is less than that of the grounding portion 1, i.e. at least partial of the grounding portion 1 is not covered by the metal foil 5 in the longitudinal direction. The frequency of the antenna 100 can be adjusted by changing the dimension of the metal foil 5 so that the antenna can be manufactured with a rough tolerance. In this embodiment, the metal foil 5 does not across the gap 203 in the longitudinal direction.

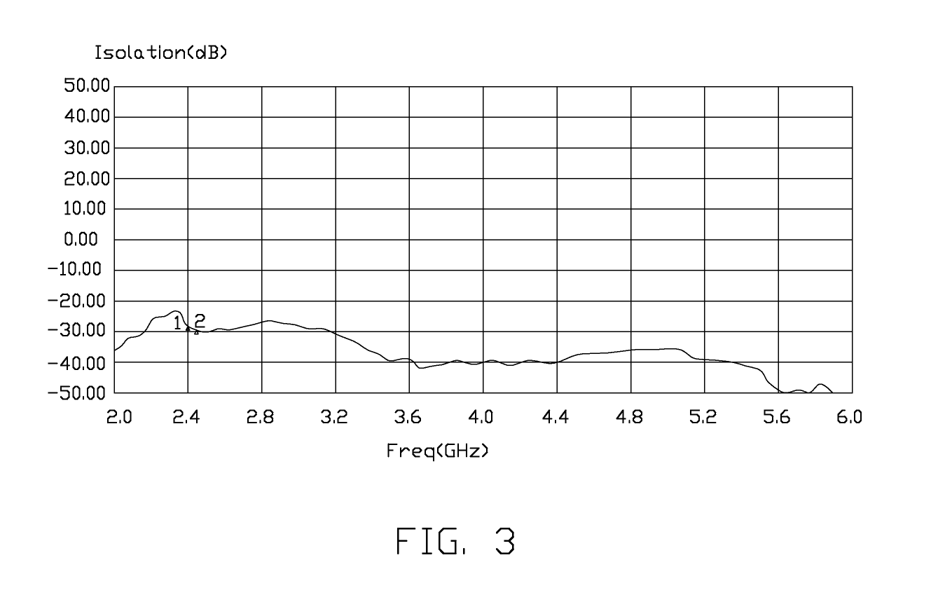

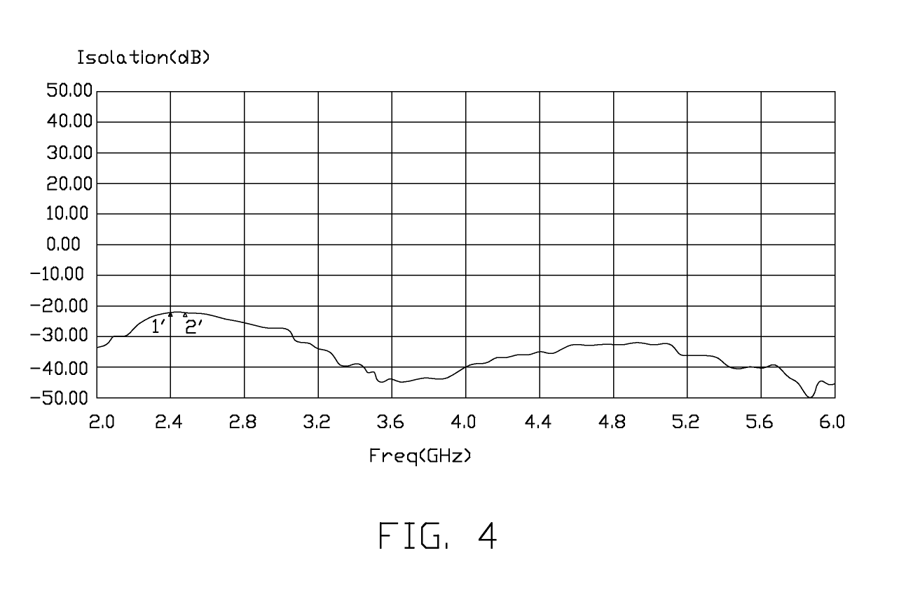

FIG. 3 shows the isolation chart of the present antenna 100. On the frequency band of 2.4-2.5 GHz, the isolation is less than −25 dB. Referring to point numbered 1, wherein the frequency is 2.4 GHz, the isolation is −28.9 dB; referring to point numbered 2, wherein the frequency is 2.5 GHz, the isolation is −29.5 dB. The antenna 100 of the present disclosure performs a high isolation. FIG. 4 is a comparison chart without the isolating portion. As the points numbered as 1′ and 2′ show, when the frequency band is 2.4-2.5 GHz, the isolation is about −23 dB, the isolation is bad.

While preferred embodiment in accordance with the present disclosure has been shown and described, equivalent modifications and changes known to persons skilled in the art according to the spirit of the present disclosure are considered within the scope of the present disclosure as defined in the appended claims.

What is claimed is:

1. An antenna comprising:
a grounding portion extending in a longitudinal direction, comprising a first section and a second section connecting with each other;
a main body extending from the first section in a vertical direction perpendicular to the longitudinal direction;
an isolating portion extending from the second section of the grounding portion, the isolating portion located beside the main body in the longitudinal direction;
a metal foil assembled on the first section of the grounding portion; and
a coaxial cable connecting the main body.

2. The antenna as claimed in claim 1, wherein the dimension of the metal foil in the longitudinal direction is less than that of the grounding portion.

3. The antenna as claimed in claim 1, wherein the isolating portion and the main body define a gap therebetween.

4. The antenna as claimed in claim 3, wherein the isolating portion is coplanar with the main body.

5. The antenna as claimed in claim 4, wherein the metal foil does not exceed the gap in the longitudinal direction.

6. The antenna as claimed in claim 1, wherein the main body comprises a connecting portion and a radiating portion extending from one end of the connecting portion, and wherein the both the connecting portion and the radiating portion comprise parts extending in the longitudinal direction and defining an opening facing towards the isolating portion.

7. The antenna as claimed in claim 6, wherein the isolating portion is substantially a rectangular frame with a cutout facing opposite to the main body.

8. The antenna as claimed in claim 1, wherein the antenna further comprises a tab extending upwardly from the first section, the coaxial cable comprises an outer conductor soldering on the tab.

9. The antenna as claimed in claim 1, wherein the frequency bands of the antenna are 2.4-2.5 GHz and 5.15-5.85 GHz.

10. An antenna comprising:
a grounding portion extending in a longitudinal direction and defining two opposite ends;
a main body extending from a medial portion of the grounding portion between said two opposite ends, the main body located adjacent to one of said two opposite ends;
an isolating portion extending from the other end and defining a gap with the main body;
a metal foil assembled on the grounding portion and adjacent to said one end; and
a coaxial cable comprising an inner conductor connecting the main body and an outer conductor connecting the grounding portion and closing to said one end.

11. The antenna as claimed in claim 10, wherein the metal foil does not exceed the gap in the longitudinal direction.

12. The antenna as claimed in claim 10, wherein the antenna comprises a tab extending upwardly from the grounding portion and closing to said one end, the outer conductor is soldered on the tab.

13. The antenna as claimed in claim 10, wherein the isolating portion is substantially a rectangular frame with a cutout facing opposite to the main body.

14. An antenna comprising:
a grounding portion extending along a longitudinal direction;
a main body extending upwardly from a middle area of the grounding portion in said longitudinal direction, said main body including a step structured connecting portion linked to the grounding portion and an L-shaped radiating portion above the connecting portion;
a tab extending upwardly around one longitudinal end of grounding portion and below the main body;
a feeding cable including an outer conductor mechanically and electrically connected to the tab, and an inner conductor mechanically and electrically connected to the connecting portion; and
an isolating portion extending from the other longitudinal end of the grounding portion with a plurality of bends extending initially toward the main body and finally ending around said other longitudinal end in said longitudinal direction; wherein
a gap is formed between the radiating portion and the isolating portion in the longitudinal direction.

15. The antenna as claimed in claim 14, wherein a metallic foil is attached to the grounding portion under the main body.

16. The antenna as claimed in claim 15, wherein one end of the metallic foil along said longitudinal direction, is terminated not to extend beyond the radiation portion in said longitudinal direction.

17. The antenna as claimed in claim 14, wherein said main body cooperates with the grounding portion to define a slot therebetween, and the tab is located in said slot.

18. The antenna as claimed in claim 17, wherein the main body defines a continuous step structure to form said slot.

19. The antenna as claimed in claim 18, wherein said continuous step structure defines a vertical section, and the inner conductor is attached to said vertical direction.

20. The antenna as claimed in claim 14, wherein the radiating portion is closer, in said longitudinal direction, to the isolating portion than the connecting portion is.
